(19) United States
(12) Patent Application Publication
(10) Pub. No.: US 2024/0352595 A1
(43) Pub. Date: Oct. 24, 2024

(54) Electrolytic Cell

(71) Applicant: Vivek Pathak, East Brunswick, NJ (US)

(72) Inventor: Vivek Pathak, East Brunswick, NJ (US)

(21) Appl. No.: 18/763,455

(22) Filed: Jul. 3, 2024

Related U.S. Application Data
(63) Continuation-in-part of application No. 17/146,390, filed on Jan. 11, 2021.
(60) Provisional application No. 62/959,957, filed on Jan. 11, 2020.

(51) Int. Cl. C25B 1/04; C25B 9/65; C25B 9/67; C25B 11/02; C25B 15/021; C25B 15/025; C25B 15/08

(52) U.S. Cl. CPC C25B 1/04; C25B 9/65; C25B 9/67; C25B 11/02; C25B 15/021; C25B 15/025; C25B 15/083; C25B 15/085

(57) ABSTRACT

Large scale exploitation of Solar energy is proposed by using floating devices which use solar energy to produce compressed hydrogen by electrolysis of deep sea water. Natural ocean currents are used to allow the devices to gather solar energy in the form of compressed hydrogen from over a large area with minimum energy transportation cost. The proposal uses a combination of well understood technologies, and a preliminary cost analysis shows that the hydrogen produced in this manner would satisfy the ultimate cost targets for hydrogen production and pave the way for carbon free energy economy.

### CROSS REFERENCE TO RELATED APPLICATIONS

This application is a continuation-in-part of U.S. application Ser. No. 17/146,390, filed on Jan. 11, 2021, which claims the benefit of U.S. Provisional Application No. 62/959,957 filed Jan. 11, 2020.

### BACKGROUND

### 1. Technical Field

The present disclosure is directed to an electrolytic cell.

### 2. Technical Considerations

Large scale and cost effective harvesting and storage of solar energy is still an open problem. A number of approaches are being attempted with the ultimate objective of supporting large scale industrially and commercially viable solar energy harvesting technologies which could enable a massive shift away from hydrocarbon fuels. This in turn would reduce the production of greenhouse gas, and thus combat global warming.

Adoption of solar power for transportation and industrial usage requires addressing the lower energy density and the inherent unreliability of solar power, which make it less suitable for transportation and industrial usage, unless storage can smooth out the unavailability caused by intermittent nature of incoming solar energy. The low energy density of sunlight requires a large collection area. If large geographical areas are used for solar energy production, then there is a problem of transporting the energy to where it is needed. Transporting the harvested solar energy to the point of consumption additionally expends energy. Thus the effective yield of harvested energy is reduced. Improving the efficiency of storage and transportation is therefore of paramount importance in solar energy harvesting.

Among the upcoming non-carbon based fuels, hydrogen is well matched to the existing transportation infrastructure. Given a cost-effective and large scale supply of compressed hydrogen fuel, it is feasible to rapidly migrate out of gasoline and diesel in a non-disruptive manner. Among the recent attempts at extracting oceanic solar energy, extracting hydrogen from water for energy usage, the following are salient:

U.S. Pat. No. 9,315,397B2 by Samuel Sivret proposes electrolysis of sea water at depth to create hydrogen and oxygen. A stationary system of pumps and turbines is used to generate hydrogen and oxygen by electrolysis of water. Having a fixed infrastructure approach limits the total energy one can gather from the invention unless a cheap and abundant power supply source is assumed.

International patent WO2015163932A1 by Joseph P. BOWER proposes electrolysis of water under pressure within a fixed chamber to generate hydrogen by electrolysis of water. Again a fixed infrastructure approach makes it unsuitable for application in solar energy harvesting.

U.S. Ser. No. 01/041,1643 by Smadja et. al. describes floating solar arrays with ability to orient the solar cells to improve the efficiency of photovoltaic generation of electricity. Having moving parts that need continuous solar tracking makes the approach less pragmatic for large ocean environment, which would be required if significant amount of hydrogen has to be generated.

U.S. Ser. No. 01/084,0572 by Denis Luz addresses the storage aspect by converting solar energy into compressed hydrogen for later use. However the approach is one of a fixed infrastructure making it cumbersome to gather solar energy from over a large geographical area.

Electrolysis frequently produces gaseous products which must be kept separate in order to prevent a spontaneous potentially explosive reaction between them. While the efficiency of electrolysis increases as the electrodes are placed closer to each other, the danger of mixing of the electrolytic products also increases because of the closer placement of electrodes where these products are being produced.

Separating these gaseous electrolytic products is a long standing problem which has traditionally been addressed through separating membranes, porous electrodes, or by forced liquid flows to keep the gases separate as they are produced during the electrolytic process. Each of these approaches introduces an additional overhead either by impeding the mass flow required for electrolysis or by requiring additional ongoing electrolytic liquid flow which not only consumes energy but also becomes a point of catastrophic failure if the flow stops and the reactive products mix inadvertently. Additionally, even if interelectrode separation is decreased (with the help of separators etc.), the tighter geometry reduces the flow of the electrolytic fluid and therefore the rate of electrolysis.

The efficiency of electrolysis is known to depend strongly on the operating pressure and temperature, with increases in temperature and pressure typically favoring the efficiency of electrolysis. While increasing the temperature of operation only requires the cell be constructed with high temperature resistant materials, increasing the operating pressure of the electrolytic cell also requires the cell to be structurally designed to hold the internal pressure safely.

### SUMMARY

Support compressed hydrogen based harvesting of solar energy, thereby making solar energy accessible for industrial and transportation usages.

Collect solar energy over large areas by harvesting solar energy falling over the oceans. Use ocean currents in order to minimize the transportation cost.

The present invention, in general terms, provides solar powered hydrogen from the ocean or other convenient water body. A hydrogen generation device floats on the water body surface and has attached solar panels generating electricity. The device is designed to withstand rough ocean conditions and is expected to be away for several months at a time when it generates the solar energy and stores it as compressed hydrogen.

The hydrogen production device, has a floating platform with positive buoyancy so that it can carry load of the other constituent parts. The device also has onboard array of sea worthy solar panels. These panels can be retracted into a tucked-away position where they will remain mechanically closed and submerged under the water surface in order to protect them from rough weather conditions. The solar panels directly convert the solar energy into electricity to be used by rest of the device. Optionally, the panels are reflective and have a focusing saw mirror pattern so as to collect the unused reflected solar energy for additional harvesting light energy through a solar panel and harvesting heat energy through high temperature electrolysis.

The electricity harvested by the solar panel is routed to an electrolytic cell that operates at a considerable depth under the ocean surface in order to produce the hydrogen compressed at the ambient water pressure present at the depth of operation. The electricity is also optionally used for high pressure high temperature electrolysis in a sealed electrolytic cell.

The compressed hydrogen produced by the electrolytic cell(s) is collected in compressed hydrogen storage tanks which also provide buoyancy to the device. The device also has an on-board computer system and electrical motors to do various operational tasks. Tasks include actions like folding up and submerging the solar panels for bad weather or dark conditions, or navigating on the sea surface by operating propellers. These operate either by drawing some power from the on-board solar panels, or by using batteries during dark conditions. The on-board computer will have visual and other sensors and will be designed to both remote control the system as well as to operate it autonomously without human intervention for long periods of time.

These and other features and characteristics of the present disclosure, as well as the methods of operation and functions of the related elements of structures and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

This invention describes a device, the Regenerative High-pressure Membrane-less Magneto-hydrodynamically accelerated Electrolytic Cell with Collector and Reactor (or R6 Electrolytic Cell), and a method to passively separate the products of electrolysis purely through passive buoyancy-induced flows. The products can be optionally routed to the Reactor in order to conduct further downstream reactions, while the Collector accumulates dense waste products. The flow patterns imposed by the internal design with ascending spiral separators placed within helical electrodes allow free unimpeded flow of ions within the electrolytic fluid along with the ability to place large surface areas of electrodes very close to each other without risking the mixing of the products. The invention gains efficiency by removing impediments to ionic mass flow, operating at high pressures and high temperatures, and by conducting the electrolytic reaction in an endothermic mode with regenerative heat transfer from the reactor stage, or from another source of cheap or waste heat.

An electrolytic cell design is disclosed in the U.S. patent application Ser. No. 17/146,390, and also partially reproduced in FIG. 8. Partial separators separate the gaseous products created at the spiral electrodes. This happens as the bubbles of the products flow upwards under their own buoyancy. The present disclosure keeps the products separate without introducing any impediments in the ionic flow path, and supporting the ability to place large surface areas of electrodes very close to each other within a small volume. However, it also provides improvements to both electrolytic efficiency (amount of Hydrogen produced as compared to the ideal value) and productivity (rate of hydrogen production per watt per liter of electrolyzer) by having the electrolysis induce its own passive buoyancy induced flow, thereby improving mixing within the electrolytic solution without mixing the gaseous products.

The current disclosure optionally employes magnetic fields, both alternating and static to improve the Hydrogen production rate based on the following physical effects: Alternating magnetic fields have been used to magnetically heat the surface layer of the electrodes which in tum causes abnormal increase in electrolytic rate because of local thermo catalytic effects. Similarly, the Lorentz force is used to increase the flow rate by having a static vertical magnetic field exist within the electrolytic volume in a direction parallel to the surface of the spiral electrodes. The existence of this force is known for some time, and it has previously been used to impart vertically upward force on the liquid at the interface with the electrode thereby hastening the separation of gaseous bubbles leading to increases in electrolytic efficiency. The current disclosure takes the other orthogonal direction, and applies force on the electrolytic liquid along the circumference parallel to the spiral arms (FIG. 8). This circumferential force, applied to the electrolytic liquid contained within a cylindrical containment vessel, has an accumulative effect because the contributions along different parts of the spiral add up as they stir the electrolytic liquid in the same rotational sense along the spiral. This Lorentz force magnifies the natural induced flow on the electrolytic liquid which is imposed by the buoyant flow of the bubbles along the sloping paths of the electrolyzer core. Additional mixing and mass-flow caused by the magneto-hydrodynamic Lorentz force within the electrolytic fluid increases the rate and efficiency of electrolysis.

Additionally, the current disclosure optionally allows for additional electrolytic efficiency improvements through regenerative heat transfer from downstream exothermic reactions producing additional useful outputs, or through the heat transfer from other sources of cheap or waste heat. The device uses the heat energy from the regenerative heat transfer for breaking additional water molecules during electrolysis, thereby gaining additional efficiency.

In the present disclosure, the Regenerative High-pressure Membrane-less Magneto-hydrodynamically accelerated Electrolytic Cell with Collector and Reactor (or R6 Electrolytic Cell), may include the following parts: the electrolyzer-core, a high pressure vessel where the electrolytic reaction occurs, the collector where the high density liquid or liquid slurry waste is accumulated, and the reactor where a downstream reaction occurs with one of the electrolytic products with regenerative heat transfer back to the electrolysis reaction. This optional regenerative heat transfer, when applied, increases the efficiency of electrolysis as the heat is used to break down additional molecules of the electrolytic fluid.

The Membrane-less electrolytic cell supports operation at extremely high pressures of up to 1000 atmospheres by enclosing the electrolytic chamber of the cell within double flanged pipe and hemi-spherical parts (#10 and #9). This structure creates the pressure vessel to contain the pressure safely. This outer shell is constructed of high strength materials like glass fiber reinforced plastic or carbon fiber composites. The shape is chosen in order to avoid concentration of stress when the cell is operating under pressure.

The R6 cell operates at a well-defined operating pressure by virtue of the pressure relief valve (#13), which releases the electrolysis product gases once the pressure exceeds the set pressure of the relief valve. For starting, the cell can self-generate the pressure as opposed to having a compressor generate the pressure. For example, during the electrolysis of sea-water or waste water, Hydrogen is produced at the cathode. This allows the electrolytic cell to build up internal pressure by forcing electrolysis within a sealed space.

Converting the entire water into hydrogen would compress the hydrogen at approximately 1240 atmospheres pressure as per the ideal gas law at 273K. Using a Pressure Relief Valve (#13), the produced hydrogen is harvested at the desired output pressure, say 700 atmosphere for supplying transportation industry fuel needs, or 1000 atmosphere for driving Carbon Hydrogen reactions on carbon rich waste in order to produce fuel from waste.

The outer high pressure vessel encloses an electrolytic chamber called the “electrolyzer core” which is of a cylindrical shape. Its internal structure drives the passive buoyancy-induced separation of the gaseous products produced at the electrodes. The cylindrical volume of the electrolyzer core contains an even number of spiral electrodes with positive and negative electrodes alternating. An example of the two spiral electrode electrolyzer core is shown in FIG. 8.

As the two gases are released on the respective electrodes, they rise upwards initially close to the electrode and then diffusing laterally as they rise up. In order to prevent the mixing of gases, the roof has a partial separator, creating a non-conducting non-porous slide which slides down between the two adjacent spiral electrodes. Multiple levels of these slides span the entire vertical extent of the electrolyzer core. During electrolysis, as the bubbles rise up on creation, they encounter the non-mixing slide and are caught on their side of the slide. Additionally, they slide upwards along the slide sticking close to the electrode from which they were produced. This flow of gases along their slides of the top also induces a flow within the liquid because of the boundary interaction between the upward flowing gas and the otherwise stationary liquid. Thus, the buoyancy of the bubbles also creates a flow within the cell that both circulates the fluid and also allows the bubbles of the two gases to flow in separate paths with negligible possibility of mixing.

The present disclosure is also directed to the following clauses:
Clause 1: An electrolytic cell, comprising: an electrolyzer configured to receive an electrolytic fluid, the electrolyzer comprising an inlet configured to receive the electrolytic fluid and a plurality of outlets configured to enable gases generated by the electrolyzer to leave the electrolyzer; at least one intermediate slab contained within the electrolyzer, the at least one intermediate slab comprising: electrodes comprising at least one anode having a spiral cross-section and at least one cathode having a spiral cross-section, wherein the at least one anode is spaced apart from and spirals around the at least one cathode; a sloping roof bridging adjacent spaced apart electrodes and comprising a partial separator, the sloping roof configured to cause gases generated at the at least on anode and the at least one cathode to travel along a spiral path, the partial separator configured to prevent a gas generated at the at least one anode from mixing with a gas generated at the at least one cathode; and a gas elevator an end of the spiral path, the gas elevator configured to allow the gas generated at the at least one anode to escape to a first outlet of the plurality of outlets and the gas generated at the at least one cathode to escape to a second outlet of the plurality of outlets without mixing thereof.
Clause 2: The electrolytic cell of clause 1, wherein the electrolytic fluid comprises a water-containing fluid, wherein the gases generated by the electrolyzer comprise oxygen gas and hydrogen gas.
Clause 3: The electrolytic cell of clause 1 or 2, further comprising a first container in fluid communication with the second outlet, the first container configured to store hydrogen gas; and/or a second container in fluid communication with the first outlet, the second container configured to store oxygen gas.
Clause 4: The electrolytic cell of any of clauses 1-3, further comprising a plurality of the intermediate slabs, the plurality of intermediate slabs comprising a first slab and a second slab.
Clause 5: The electrolytic cell of clause 4, wherein the first slab is arranged above the second slab.
Clause 6: The electrolytic cell of clause 5, wherein a gas elevator of the first slab is in fluid communication with a gas elevator of the second slab such that: the gas generated at the at least one anode of the first slab mixes with the gas generated at the at least one anode of the second slab; and/or the gas generated at the at least one cathode of the first slab mixes with the gas generated at the at least one cathode of the second slab.
Clause 7: The electrolytic cell of clause 5 or 6, wherein the first slab is interlocked with the second slab.
Clause 8: The electrolytic cell of any of clauses 1-7, wherein the electrolytic cell does not comprise a membrane separator.
Clause 9: The electrolytic cell of any of clauses 1-8, further comprising a collector arranged below the at least one intermediate slab configured to collect liquid waste generated at the at least one anode and/or the at least one cathode, wherein the liquid waste slides down the sloping roof to the collector.
Clause 10: The electrolytic cell of any of clauses 1-9, wherein: the at least one anode comprises a vertical surface electroplated with an anodic material; and/or the at least one cathode comprises a vertical surface electroplated with a cathodic material.
Clause 11: The electrolytic cell of any of clauses 1-10, further comprising: a reactor comprising metal particles collected from an ocean floor, the reactor reacting the metal particles to form a metal hydride and excess heat.
Clause 12: The electrolytic cell of clause 11, wherein the excess heat is used by the electrolyzer for electrolysis.
Clause 13: The electrolytic cell of clause 11 or 12, wherein the metal particles are contained in a ball mill, wherein hydrogen gas generated by the electrolyzer is flowed to the ball mill to react the hydrogen gas with the metal particles to form the metal hydride.
Clause 14: The electrolytic cell of any of clauses 1-13, further comprising: a waste reactor comprising a dirty water comprising carbon-rich material that is reacted with hydrogen gas generated by the electrolyzer to generate a hydrocarbon fuel, a cleaner water, and excess heat.
Clause 15: The electrolytic cell of clause 14, wherein the excess heat is used by the electrolyzer for electrolysis.
Clause 16: The electrolytic cell of clause 14 or 15, wherein the cleaner water is flowed to the inlet of the electrolyzer.
Clause 17: The electrolytic cell of any of clauses 1-16, further comprising: a solar panel comprising a photovoltaic cell on which solar heat falls; and a heat exchanger configured to heat the electrolytic fluid using the solar heat that falls on the solar panel.
Clause 18: The electrolytic cell of any of clauses 1-17, wherein the heat exchanger causes a temperature decrease of the solar panel.
Clause 19: The electrolytic cell of any of clauses 1-18, wherein: an alternating magnetic field is applied to magnetically heat a surface of the at least one anode and/or the at least one cathode; and/or a Lorentz force is applied to the electrolytic fluid in a direction parallel to a surface of the at least one anode and/or the at least one cathode.
Clause 20: The electrolytic cell of any of clauses 1-19, further comprising: a power controller configured to apply a voltage and/or a magnetic field to cause an electrolytic reaction of the electrolytic fluid.

### BRIEF DESCRIPTION OF THE DRAWINGS

Non-limiting embodiments of the present invention are described by way of example with reference to the accompanying figures, which are schematic and are not intended to be drawn to scale. In the figures each identical or approximately identical component is represented by a numeral. For purposes of clarity not every component is labeled in every figure, nor is every component of every embodiment of the invention shown where illustration is not necessary to allow a person of ordinary skill in the art to understand and build the invention. The figures are the following:

FIGS. 1 and 2 show the different side views of the device converting solar energy into compressed hydrogen.

FIG. 3 shows the top view of the same.

FIG. 4 shows the top view and the side view of the sealed high pressure electrolytic cell.

FIG. 5 shows the open electrolytic cell which operates under hydrostatic pressure.

FIG. 6 outlines the hydrocarbon pathway that uses the heated compressed hydrogen for converting waste into useful fuel gases.

FIG. 7 shows a prior art force flow induced separation in a membrane-less cell.

FIG. 8 shows a high pressure separator-less electrolyzer.

FIG. 9 shows a front view of an electrolyzer.

FIG. 10 shows a top view of an electrolyzer.

FIG. 11 shows a cross-section of an electrode.

FIG. 12 shows an isometric view of an electrolyzer slab.

FIG. 13 shows a bottom-up isometric view of an intermediate slab.

FIG. 14 shows a bottom-up isometric view of a top slab.

FIG. 15 shows an isometric view of a top slab.

FIG. 16 shows a solid hydride electrolyzer.

FIG. 17 shows an isometric view of a solid hydride electrolyzer.

FIG. 18 shows a right hand side view of a solid hydride electrolyzer.

FIG. 19 shows a front view of waste to fuel electrolyzer.

FIG. 20 shows a front view of a solar thermal photovoltaic electrolyzer.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

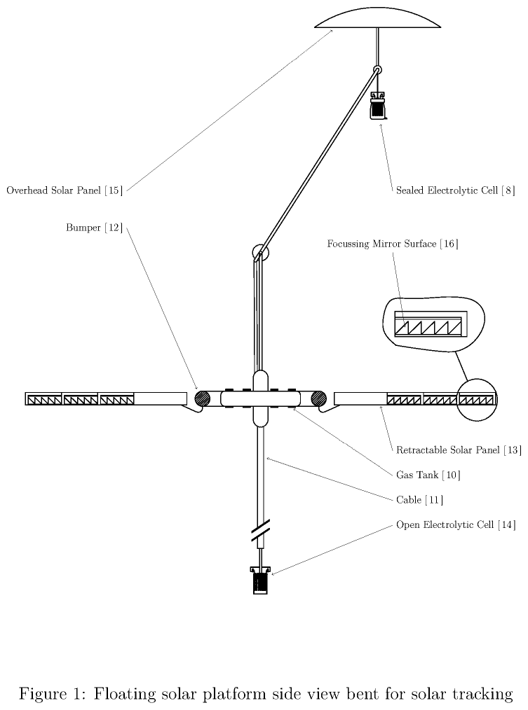

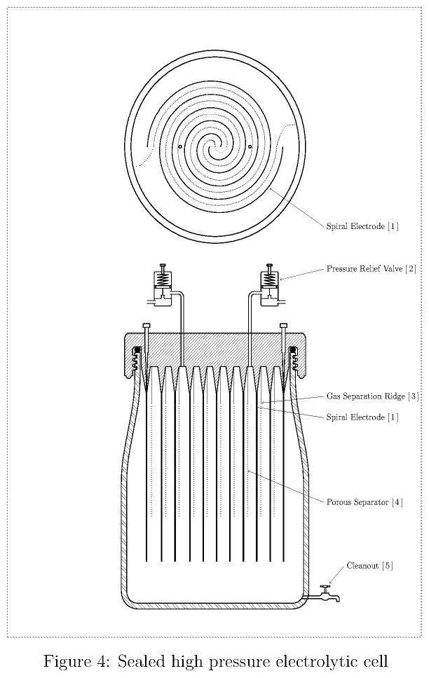

The sketch in FIG. 1 shows an exemplary arrangement of the preferred embodiment for the invention. The device has one or more cylindrical buoys which also serve as Gas Tank [10] and are referred as such in the remaining discussion. The Gas Tank [10] stores the hydrogen produced by the device. There is an attachment on one side for the submerged payload which is attached to the buoy. The platform has an upright pole on the other end which rises above the water level and serve as a mount point for the Sealed Electrolytic Cell [8] (see FIG. 4) as well as commercially sourced radio antennae, sensors, and cameras.

One potential embodiment of the platform is in the form of a cylindrical buoy with a buoyancy of 5000 kg. The volume of such a buoy is approximated below by using a cylinder instead of the spherical end of the buoy. Similarly, density of 1.0 kg 1⁻¹ is used instead of the density of sea water which can vary with temperature and salinity.

$$V = \frac{5000 kg}{10 kg {1}^{- 1}} = 5000 l \qquad ( 1 )$$

The cylinder can have a radius of 0.8 m which gives the height of cylinder to be 2.486 m. Construction of ocean-worthy buoys is a well developed standardized industrial process. This embodiment proposes to use a buoy made with 10 mm stainless steel sheet with standard processes.

The weight of such a buoy is approximated using the surface area of the cylinder and using 8000 kg m⁻³ as the density of steel. The buoy weighs approximately 1160 kg, and has sufficient buoyancy to carry a payload of 3839 kg, as shown in Table 1.

TABLE 1
Positive buoyancy is achievable with a number of combinations
of buoy parameters and payload weight.
Steel buoy design (representative)

| Component | Description with units (SI) | Value |
|---|---|---|
| Buoy | Volume (liters) | 5000.000 |
| | Radius (m) | 0.800 |
| | Height (m) | 2.487 |
| | Curved area (square meter) | 12.500 |
| | Flat area (square meter) | 2.011 |
| | Total surface area (square meter) | 14.511 |
| | Thickness of steel (m) | 0.010 |
| | Volume of steel skin (cubic meter) | 0.145 |
| | Density of steel (kg/cubic meter) | 8000.000 |
| | Weight of buoy (kg) | 1160.849 |
| | Carrying capacity (kg) | 3839.151 |

The entire device is expected to float on the ocean surface while at the same time being dragged in ocean currents by virtue of the drag felt on the Cable [11] and the Gas Tank [10]. These devices shall be placed in those areas of the ocean where the ocean currents naturally form a loop. Fortunately, many such ocean current systems exist. Using the ocean current allows one to collect solar power from over a large area as well as to transfer it cost-free to a convenient collection location.

In order to keep the device on its desired trajectory, the floating platform also has navigational capability. This is effected either through commercially available on-board computer control, or through commercially available remote control by human operators. This requires propulsion and control, GPS capability, cameras, and other standard navigation and communication devices. Since these are well developed technologies, we will use existing prior art to add these capabilities to the device.

TABLE 2
Physical Properties of Compressed Hydrogen

| Component | Description with units (SI) | Value |
|---|---|---|
| Quantity of | 1 atmosphere in N per sq m. | 101325 |
| Hydrogen | Pressure of hydrogen in | 400 |
| | atmospheres | |
| | Pressure (N per sq m) | 40530000 |
| | Volume of Tank (cubic m) | 0.1 |
| | Absolute temp of deep sea (K) | 275 |
| | Molar gas constant R (J/kg K) | 0.167 |
| | Number of moles of gas in | 88133.316 |
| | the cylinder i.e. Volume of | |
| | tank above, as per the gas | |
| | law: n = PV/RT | |
| | Mass of one mole of H2 (kg) | 0.002 |
| | Mass in kg of compressed H2 | 177.666 |
| | in the cylinder | |
| Buoyancy of | Volume of water displaced by | 0.100 |
| the tank | tank (cubic meter) | |
| | Density of deep sea water | 1055.000 |
| | (kg per cubic meter) | |
| | Weight of water displaced | 105.500 |
| | The weight already provided | 177.666 |
| | by compressed hydrogen | |
| | Effective weight H2 contained | 72.166 |
| | in the cylinder (kg) | |
| Energy | Hydrogen combustion energy | 141.800 |
| content | (MJ/kg) | |
| | Mass of hydrogen in tank (kg) | 177.666 |
| | Total energy from 100 L tank | 25193.065 |
| | (MJ) | |

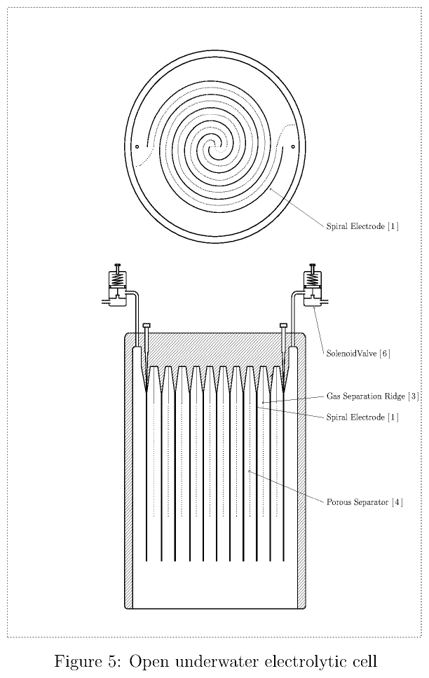

The electrolysis of sea water is done at the ambient deep sea pressure as shown in FIG. 5. This allows one to create and store compressed hydrogen without having to expend energy for compressing it. Considering electrolysis at a depth of approximately 4 km, i.e. approximately 400 atmospheres pressure, the Hydrogen created through electrolysis of sea water would be emitted through the Solenoid-Valve [6] which opens when the hydrogen bubble reaches the bottom of the Gas Separation Ridge [3]. The valve would close when the water level reaches to the top. The solenoid valve as well as the sensors and control for closing and opening the valve at appropriate levels are commercially available. The released hydrogen has the physical properties as described in Table 2, and is at a compression level suitable for use in transportation or industry.

An alternative embodiment allows the electrolytic cell to build up additional internal pressure by forcing electrolysis within a sealed space. As shown in FIG. 4, the electrolysis is within a constrained volume. Converting the entire water into hydrogen would compress the hydrogen at approximately 1240 atmospheres pressure as per the ideal gas law at 273K. Using a Pressure Relief Valve [2], the produced hydrogen is harvested at 700 atmospheres. The sealed electrolytic cell is constructed in such a way that the two Spiral Electrode [1] spiral around each other, thereby providing increased surface area for electrolysis. Opposite polarity electrodes are separated by a spiral ridge like shape, the Gas Separation Ridge [3] on the bottom surface of the top lid of the electrolytic cell. Water level is prevented from falling below the ridge line in order to prevent mixing of the gases. When water reaches this threshold, additional water is pumped in through a separate inlet at 700 atmospheres, the opening pressure of the relief valve. This causes the hydrogen to flow out at the same 700 atmospheres pressure through the relief valve until the water level rises to a top threshold level which is chosen so as not to overflow at the normal closing rate of the pumped in water. The pumping of water at high pressure is done with commercially available hydraulic systems, and the high level, low level transitions to drive the water pumping are also done through commercially available control systems.

The electrolysis of sea water and brackish water produces chlorine at the positive electrode. Chlorine liquefies at the operating pressure of the cell. Being heavier than water it shall sink and be discharged through the Cleanout [5]. Continuous depletion of chloride ions makes the remaining solution alkaline thereby suppressing the production of corrosive chlorine at the positive electrode.

Yet another alternative embodiment works by harvesting hydrogen at a pressure of 1000 atmospheres and then transferring it into a waste reducing chamber containing ocean plastics or household waste or other carbon rich waste, as shown in FIG. 6. The hydrogen is heated, approximately to 700K (430 C or 800 F) by the Inline Gas Heater [9]. The mixture is turned, exposed to ultra-violet light to encourage reduction reactions which are endothermic and perform better under catalysis and high pressure. The resulting gas is a mixture of Hydrogen, Methane, Methyl alcohol, Water vapor etc along with some inorganic compounds. This mixture is cooled to 300K and then expanded to 700 atmospheres. By the ideal gas laws, the resulting adiabatic cooling results in the gas being cooled to 210K. This cool gas mixture at −63 C and 700 atmospheres pressure is distilled to extract out the methane which ceases to be gaseous under those conditions. This pathway and embodiment would allow the conversion of oceanic plastic and oil spills, mixed domestic trash and other carbon rich waste into methane gas that can be used in place of natural gas for heating and power.

The various preferred embodiments described previously for the electrolysis cell assembly can be made further energy efficient by using the waste heat of traditional nuclear or thermal power plants to reduce the need for electrical energy required for electrolysis as well as that required for the thermal formation of methane from organic and plastic waste matter.

The Retractable Solar Panel [13] is attached to the device as shown in FIG. 1. The solar panels can be folded and then with a hinge can be turned downwards to go under the water surface when not it use or to protect them from rough seas. This requires the solar panel to have neutral buoyancy, which can be achieved by traditional design methods. The arc of the circle away from the maximum opened state of the solar panels is used to attach Bumper [12] which will protect the solar panels when they are in a closed downward position.

Considering the solar panels of 1000 m², the energy produced and the cost of solar panels are estimated in Table 3 based on specifications of commercially available products.

TABLE 3
Energy and Cost of Solar Panels

| Component | Description with units (SI) | Value |
|---|---|---|
| Energy Produced | Area of solar panel (sq m) | 1000 |
| | Watts per square meter of solar | 220 |
| | panel surface (market value) | |
| | Convert to KW/sq m | 0.22 |
| | Peak kilowatts at noon sun above | 220 |
| | Efficiency correction for non | 0.3 |
| | noon and latitude (estimated) | |
| | Average power (KW) | 66 |
| | Total evergy per day kWH | 1584 |
| | KwH to MJ | 3.6 |
| | Total MJ per day | 5702.400 |
| | Days to fill cylinder | 4.418 |
| | Total cylinders per year | 82.674 |
| Cost | Cost of solar panel household | 3.05 |
| | (Dollar per watt peak) | |
| | Cost projected for marine solar | 3.75 |
| | panel (Dollar per peak watt) | |
| | Total peak power we have (Kw) | 220 |
| | Cost of the solar panels | 825000 |
| | (DOLLARS) | |
| | Life of solar panel (years) | 15 |
| | (from market values) | |
| | Cost amortized per year ($) | 55,000.00 |

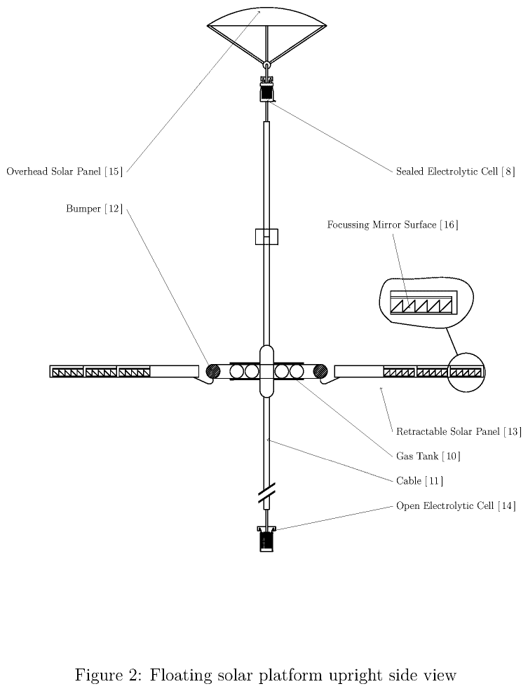

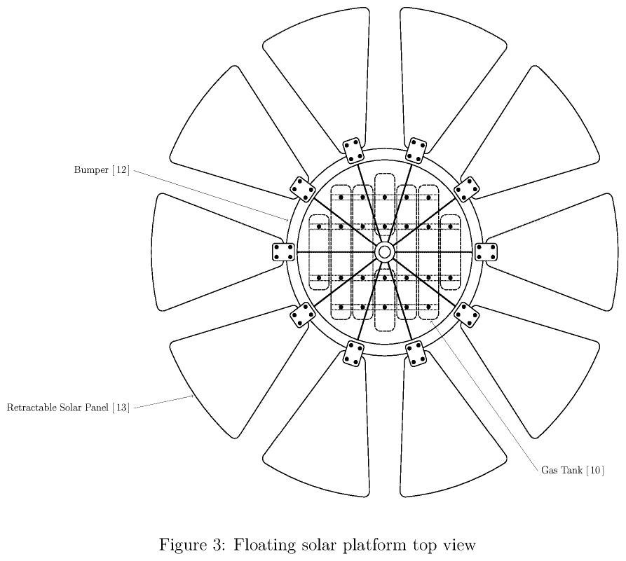

The Retractable Solar Panel [13] is designed with focusing reflective backing, the Focusing Mirror Surface [16] so that some of the sunlight falling on the solar panel is reflected back towards the suspended Sealed Electrolytic Cell [8]. Some of this radiation is converted to electricity by the Overhead Solar Panel [15] which moves to do approximate solar tracking as indicated from FIGS. 1 and 2 This allows the use of solar heat as well as photovoltaic electrical power to perform electrolysis of water. An additional benefit of the reflection is that solar heat instead of falling on the absorbing sea water is reflected away, additionally reducing to a miniscule degree the warming of the ocean. The electrical power generated by the solar cells is also transmitted down to the Open Electrolytic Cell [14] which collects Hydrogen through the Cable [11] but allows Oxygen to bubble away into the sea water.

The device uses currently available electrolytic cell technology for the electrolysis of sea water. Similarly, the transmission of electrical power over 4 km long wires and conversion of voltages to meet electrolytic requirements are also built using standard well known engineering methods. Using 66% as the overall efficiency of electrolysis and power transmission, we arrive at the estimates of Hydrogen production as shown in Table 4.

TABLE 4
Production of Compressed Hydrogen

| Component | Description with units (SI) | Value |
|---|---|---|
| Electrolytic | Energy efficiency of cell | 0.666 |
| Cell | and electrical transmission | |
| | (assumption) | |
| | Power being used for | 43.956 |
| | electrolysis (kW) | |
| | Voltage of electrolysis | 2 |
| | Amperes | 21,978.000 |
| | Faraday constant C per mol | 96,485.333 |
| | moles generated per second | 0.228 |
| | Seconds to fill cylinder | 386,912.926 |
| | Days to fill cylinder | 4.478 |

Using the data in Table 4 and Table 2, it follows that the given embodiment produces over 12000 kg of compressed Hydrogen per year. Solar panels are expected to be the main cost driver of the device. Given the amortized cost estimated in Table 3, it follows that the Hydrogen production cost is projected to close to be $4/kg, which is the ultimate cost target of the US Department of Energy for Hydrogen economy.

TABLE 5
Load Carrying Capacity of Suspension Cable

| Component | Description with units (SI) | Value |
|---|---|---|
| Cable | Diameter per cable (mm) | 3.5 |
| Specification | Redudancy number of cables | 1 |
| | Radius (mm2) | 38.488 |
| | Strength of wire as per spec in PSI | 45,000.000 |
| | Pounds per square mm | 69.750 |
| | Total strength of wire in pounds | 2,684.563 |
| Weight | Lenght of wire = Depth of operation | 4,000.000 |
| | (m) | |
| | Volume of aluminium (cubic meter) | 0.154 |
| | Density of Al kg/m3 | 2,700.000 |
| | Weight of Al wire (kg) | 415.620 |
| | Weight in pounds | 916.027 |
| | Carrying capacity per wire (lb) | 1,768.535 |
| | Carrying capacity per 3.5 mm kg | 802.421 |
| | Weight of electrolytic cell, | 50.000 |
| | assembly to change cylinder and | |
| | close cylinder when full | |
| | Weight of empty cylider (kg) | 60.000 |
| | Weight of hydrogen at 400 atm (kg) | 177.666 |
| | Total payload weight at depth (kg) | 287.666 |
| | Residual strength/carrying capacity | 514.754 |
| | (kg) | |

The Cable [11] (FIG. 1) is designed to carry the weight of the Open Electrolytic Cell [14] as well as the electrical wires and gas carrying pipes which are attached to the cable with ties at regular intervals as is done in similar under water applications. The material used in the table is marine anodized aluminum wire/cable alloy T6061, which is an aluminum alloy used for marine applications. The structural feasibility of the solution can be examined by calculating the load on the wire as shown in Table 5.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

The electrolyzer core is composed of several slabs, which are described in detail, in the following sections within the representative configurations. The configurations arise because of including or not including the reactor and the collector. The reactor can be replaced with alternative source of heat, while the collector only may be used when there are solid or liquid reactants produced during electrolysis.

### Configurations

Several configurations are possible and a few non-limiting, salient ones are described in the following sub sections. One such reaction transforms the reactants to another form with additional benefits, such as the case and safety of storage and transportation provided by the configuration working with solid metal hydrides as a safer economical way of storing and transporting green Hydrogen. Another produces additional reactants of value, as is shown in the configuration working with carbon rich waste and converting it to fuel. The regenerative heat transfer can also be provided directly in addition of being fed back from the downstream reactor stage. This is shown in the configuration consuming the solar heat captured by solar photovoltaic cells regeneratively, thereby increasing the efficiency of both the electrolysis as well as the photovoltaic cell because of the heat transfer induced cooling of the solar cell.

Even though the design can be configured to support potentially an unlin lited number of operating pressure and temperature combinations along with the corresponding electrolytic reactions and downstream reaction combinations, the following three configurations with applications to areas of high environmental value are described in detail in this patent application.

### Separator-Less High Pressure Electrolyzer Configuration

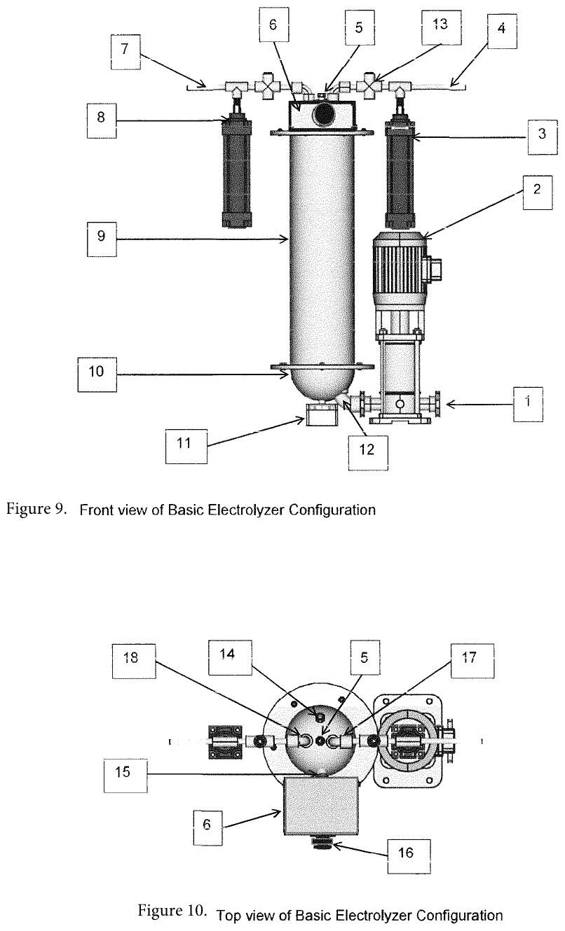

The basic minimum configuration, called “Separator-less high pressure electrolyzer configuration” is shown in FIG. 9. Here, the optional regenerative heat transfer is provided through the hot electrolytic fluid being provided through the inlet (#1). The specific temperature of the fluid depends on the electrolytic reaction and the heat transfer considerations within it, as the example reaction, the electrolysis of water reaction operating at 7 bar −700 bar would operate at temperatures 80 C to 300 C.

The electrolytic fluid is pumped by the pump (#2) to a pressure higher than the internal pressure within the electrolyzer held by the pressure vessel, which is created by the Double Flanged pipe (#9) and the two hemispherical headed dead end flange parts (#10). When this electrolyzer is filled with the electrolytic fluid (e.g., sea water, brackish water, waste water, natural fresh water, or alkaline water for Hydrogen production) and electrical current is provided to the controller (#6), Oxygen gas and Hydrogen gas are produced on the outlets (#4) and (#7) respectively. These outlets are downstream of pressure relief valves (#13), which permit the release of gases only when the internal pressure matches or exceeds a preset threshold. The release pressure depends on the application and can vary from as low as 7 bar for off-grid large volume storage in retired or refurbished traditional gas storage tanks or could be 350 bar or 700 bar for filling up modern Hydrogen fueled vehicles. Higher pressures up to 1000 bar are used in later defined configurations which are described in the section Waste To Fuel Electrolyzer addressing “Carbon rich materials to Synthetic hydrocarbon fuels” below.

Due to the continuous operation of the electrolyzer (e.g., in FIG. 9), as the water gets transformed into Oxygen and Hydrogen, the pump (#2) keeps switching on and off to push water within the pressure vessel through the inlet (#12). This maintains the proper electrolytic fluid level within the electrolyzer. In order to buffer the outputs, Oxygen and Hydrogen gases are also stored in standard gas storage tanks, (#3) and (#8) respectively. The internal electrolyzer core separates out Chlorine when operating on sea water because Chlorine is liquified at the elevated operating pressure beyond 20 bar. When operating on sea water or other chloride rich water, the operating pressure may be above the liquefaction pressure of chlorine gas. This waste liquid chlorine is available at the Collector (#11). Finally, stray gases may accumulate from dissolved impurities in the electrolytic fluid or may also result from parasitic current flows involving the containment vessel. Such spurious waste gases are released from the gas waste opening (#5) of the pressure vessel.

The top view of the basic configuration is shown in FIG. 10. The view shows that the electrical transmission wires enter the pressure vessel at the electrical input (#15) so that the controller (#6) can drive electrolysis within the pressure vessel. There is also an emergency shutoff switch (#16) to immediately stop the electrolysis and to depressurize the pressure vessel using the gas waste opening (#5) of the pressure vessel. As required for pressure safety, there is a safety valve (#14) which opens and releases excessive pressure within the pressure vessel. It is technically a pressure relief set and tested to release at a pressure lower than the ultimate strength of the pressure vessel.

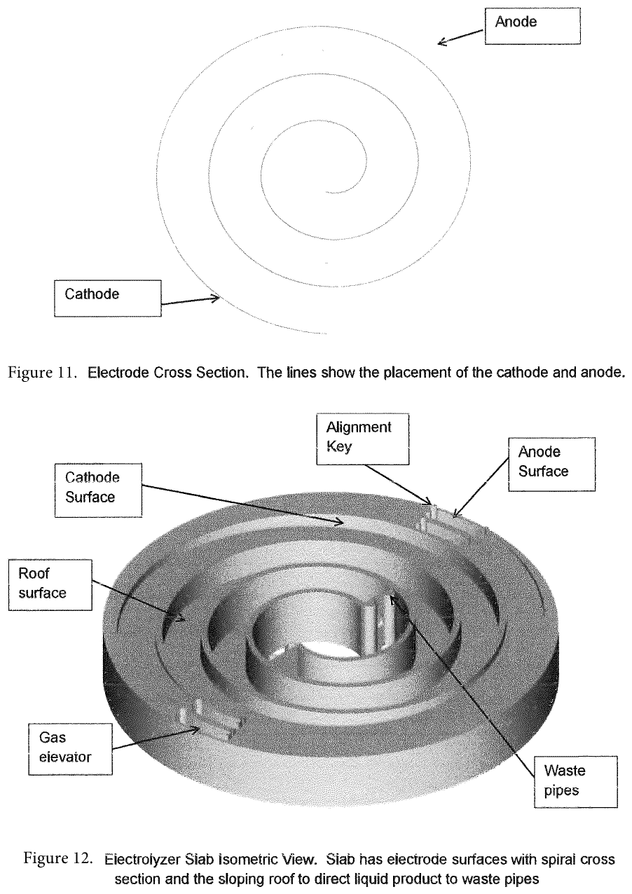

The pressure vessel, containing the electrolyzer core, is formed by the double flanged pipe (#9) and the two hemispherical headed dead end flange parts (#10). The electrolyzer core within contains a number of 3D printable cylindrical slabs which fit within the cylindrical pressure vessel. The cylindrical slabs have vertical electrode surfaces with the spiral cross section as shown in FIG. 11. The cylindrical slabs also have a sloping roof with a partial separator. The slope on the roof causes the gases generated on the electrodes to travel along a spiral path, while the partial separators prevent the product gases from mixing. The two gas streams are kept separate as they rise up along the electrolyzer core within the pressure vessel and eventually exit it at the Oxygen and Hydrogen exits (#3) and (#8) as shown in FIG. 9. The specific spiral cross sectional layout of electrodes, as shown in FIG. 11, is generated by spiraling the electrodes around each other 3 times. However, depending on the production methodology and sizing, the number of spiral windings may be done greater or lesser number of times. Since the interelectrode separation is fixed, the inner boundary radius of the electrolyzer core constrains the winding count because the electrolyzer slab parts fit snug within the pressure vessel. Of the several electrolyzer slabs required to fill up the height of the pressure vessel, there are three distinct shapes involved: top most, bottom most, and the intermediate slabs—i.e. the intermediate slab shape can be present more than one times, with the count depending on the application. A tabletop version could have 10 intermediate slabs, so that 80% of the volume participates in optimized electrolysis. A large utility scale one could be submerged in a deep well or in a deep part of the ocean, and could have hundreds or perhaps even thousands of intermediate slabs.

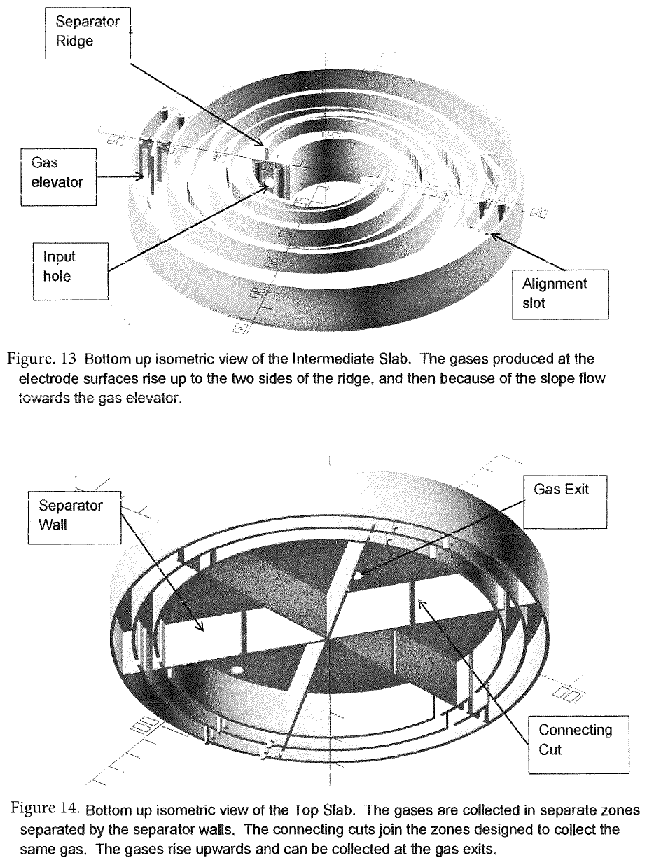

The intermediate slab has spiral winding electrodes on the vertical walls of the electrolyzer slab shape, as shown in the Isometric view in FIG. 12. The vertical wall surfaces are electroplated during manufacturing, and they function as the electrodes on which the Hydrogen and Oxygen bubbles are generated when the electric current is switched on by the Controller (#6). The surface bridging the two vertical surfaces—or the “roof surface”—has a slope so that it is flush with the bottom level of the slab when the surface is close to the core of the slab, and this surface is flush with the top level of the slab when close to the “ends” of the spiral. This sloped surface provides the following buoyancy properties: a) The liquid products if produced at the electrode traverse downwards towards the center of the slab on the top side of the surface, and b) the gaseous products produced at the two electrodes are kept separate, The separation happens because the bottom side of this roof surface has a “separator ridge” (e.g., a partial separator) separating the bubbles in the region below it into two non-mixing regions. This is shown in a bottom perspective view of the intermediate electrolyzer slab as shown in FIG. 13. The bubbles produced at the two electrodes rise up and stay on their own side of the separator ridge, but buoyantly flow outwards along the top of the bottom side of the roof surface because of the slope of the roof.

At the ends of the spiral electrodes, they enter a region marked “Gas elevator” as shown in FIG. 13, which allows free vertical motion without vertical partitions across the slabs. The gases remain separate as they rise straight upwards to the top most slab. Numerous intermediate slabs sit on top of each other in an aligned manner because of the “Alignment slot” (FIG. 13) and the “Alignment key” (FIG. 12) which exist on opposite sides of the identical intermediate slabs. This ensures that all the gas elevators align. Upon assembly, the effective shape has “upward sloping spiral arm cavities” with spiral cross section electrodes as the side walls of the cavities. This shape allows the gases to move upwards in an orderly fashion through the “gas elevator” without mixing because of the constraints of geometry and buoyancy. Additionally, since the separation of the gases is done by the divider of the slab directly above the slab producing the gases, the top most intermediate slab is not electroplated, and hence does not generate any gases. It however divides the gases as required for safety.

The motion of the gas bubbies within the upward sloping spiral arm cavities induces a shear force on the top layer of the electrolyte liquid surface within the spiral arms. Similarly, the vertical upward flow of gas bubbles in the roof-less “gas elevator” (FIG. 13) areas at the end of the spiral arms imparts an upward force in the electrolytic liquid within these regions. The resulting outward flow of the electrolytic fluid within the spirals and an upward flow within the elevator regions increasing the rate of ionic mixing and hence the rate of electrolysis. The outward flow of the electrolytic fluid, which also keeps the bubbles of the two gases separate, is autonomous and caused purely by buoyancy induced flows.

The electrolytic may cell autonomously transports the two gases while maintaining separation purely by buoyancy and constraints of geometry leading to both increased safety and increased efficiency.

This is in contrast to existing systems. The design presented in this application is safer because failure of a pump cannot cause inadvertent mixing, and also more efficient because additional mixing of the fluid is achieved without expending any energy. Notice this is just a compound gain in efficiency achieved by the internal shape of the electrolyzer. The electrical current carried by the ions faces lesser resistance i.e. lesser amount of over voltage is required to produce the same electrolytic reaction. While traditional separator and porous electrode designs add impediments to the flow thereby increasing the resistive losses, the present electrolyzer instead has a design that provides better mixing and therefore higher efficiency than the standard electrolytic efficiency for the given electrode electrolyte combination.

The device may be able to safely handle the asymmetric production of gases (hydrogen and oxygen) during electrolysis by having the volumes for the storage of bubbles of the two gases be in the same proportion as the ratio of production of the gases (e.g., 2:1 for hydrogen:oxygen in water), along with an additional bias of up to 10% for one of the gases, and an dynamic transient shutoff for the exit valve of the other gas.

The continuous outward flow in every intermediate slab ends at the “gas elevator”, as shown in FIG. 13. This is a vertically connected space which allows the respective gas to rise up vertically and reach the topmost slab directly. An important factor in the design of the top slab is the fact that electrolytic gases are typically produced in given stoichiometric ratios. For example, the electrolysis of water produces Hydrogen and Oxygen in proportion of 2:1; and this ratio holds for each of sea water, brackish water, waste water, natural fresh water, or alkaline water because only the water molecule is electrolyzed. The topmost slab is designed (according to the specific electrolytic reaction) in a manner such that the volume available for storing the gases in the topmost slab is in the same proportion as the proportion of production of gases. The top-most slab for the water electrolysis is shown in FIG. 14. The volume within the top slab is divided into zones separated by “separating walls”. There are “connecting cuts” within some of the separating walls so that in the end, the two connected regions are created with the volume in the ratio of 2:1.

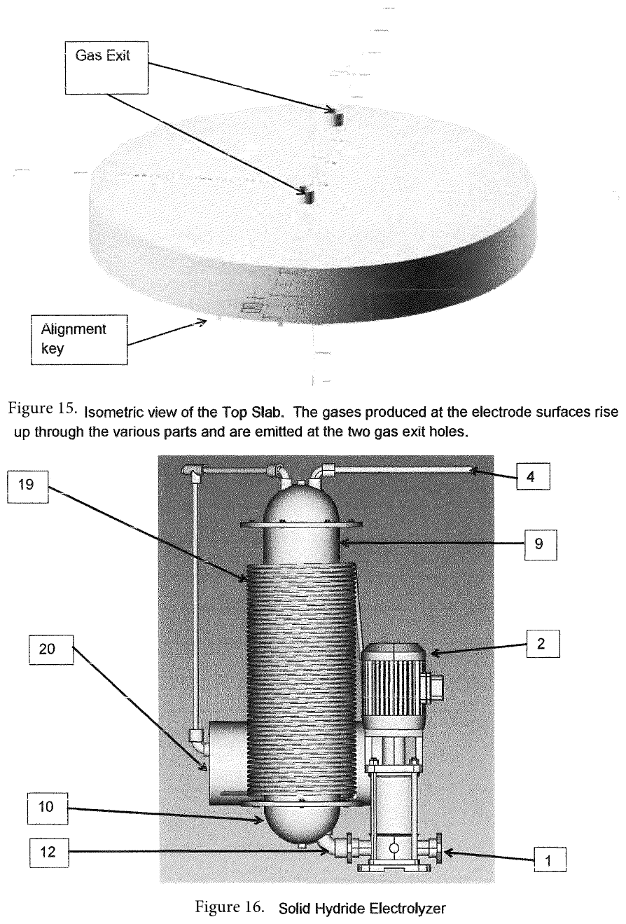

The other side of the top slab is shown in FIG. 15. The two gases, having been kept separate throughout their journey through the various slabs, are available on the gas exit holes shown in FIG. 15. The gases exiting these holes travel out through the respective gas exits #17 and #18 in FIG. 10.

### Solid Hydride Electrolyzer

This Solid Hydride Electrolyzer configuration, as shown in FIG. 16, supports the high efficiency production of metal hydrides suitable for safe and long term storage and transportation of green Hydrogen. This configuration supports the electrolysis of sea water, brackish water, waste water, natural fresh water, or alkaline water with collection of liquid chlorine in the collector causing a progressive suppression of chlorine production. A heat transfer may occur from the exothermic reaction in the reactor coming from the hydrogenation of stoichiometrically designed metal nanoparticles granules, metal waste, or metal nodules collected from the ocean floor. The end products of these reactions arc solid metal hydrides like Mg2FcH6, Mg2CoH5, Mg2NiH4, MgH2, AlH3, etc. depending on the metal mix and the reaction temperature and pressure conditions.

The metal hydride formation reaction is highly exothermic. The device allows using the surplus heat from metal hydride formation reaction to create additional Hydrogen beyond what would result from the electrical power alone used in the electrolysis. The additional Hydrogen leads to additional heat production, which in tum leads to additional Hydrogen production, hence the improvement has compounded gains in efficiency.

This configuration, as shown in FIG. 10, has the electrolytic fluid being pumped in through the inlet (#1). The water is pressurized to a pressure higher than that within the pressure vessel formed by the parts #9 and #10 and enters the pressure vessel at inlet #12. This aspect of the electrolyzer functionality is identical to the basic configuration described earlier. Once the electrolyzer core within the pressure vessel starts receiving the electrical current, Hydrogen and Oxygen gases are formed at the ambient pressure within the pressure vessel. Oxygen is released at outlet #4 and can be collected or transported away with a suitable mechanism. Hydrogen is produced and routed to the downstream reactor stage composed of the ball mill part #20. The ball mill is a hard rotating cylinder containing a hard ball and nanoscale metal particles within. As the Hydrogen gas is produced within the electrolyzer core during electrolysis, it flows to the ball mill and the metal nano particles start reacting with Hydrogen. The specific mix of the metal particles depends on the applications, and the hydrogen uptake and release temperature depend on the mix. As the metal hydride keeps getting formed, Hydrogen is consumed, and the Hydrogen pressure declines in the pipe connecting the pressure vessel to the ball mill. A large amount of heat is also produced which needs to be routed away in order to avoid dehydrogenation which happens at elevated temperatures (with exact hydrogen release temperature depending on the metal nano particles mix). The heat exchanger (#19) carries away the heat produced in the ball mill because of the Hydrogenation reaction and transfers it to the electrolytic fluid within the pressure vessel. As described previously, the efficiency of electrolysis improves as heat is transferred to the electrolytic fluid. The stability and rate of the Hydrogenation reaction also improves as the heat transfer keeps the temperature of the metal nanoparticles from rising, which favors hydrogen absorbtion. Once the Hydrogenation is complete (or the Hydrogen absorbtion rate declines) the metal Hydrides formed in the ball mill can be packaged and be used for safe transport and storage of Hydrogen.

The device may be able to convert the waste heat of hydrogenation to produce additional amounts of Hydrogen during electrolysis, and to save that Hydrogen in the form of solid metal hydrides for safe long term storage or transportation of Hydrogen.

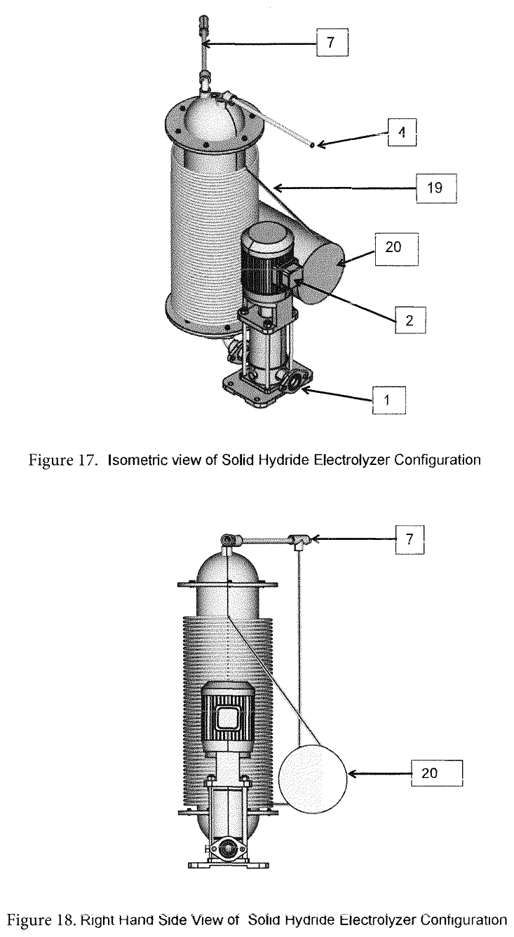

The isometric view of the Solid Hydride Electrolyzer is shown in FIG. 17. This configuration of the device supports the production of gaseous Hydrogen in addition to solid metal hydrides suitable for long term storage and safe transportation of Hydrogen. The compressed gaseous Hydrogen is available on outlet #7. Compressed gaseous Hydrogen is available on outlet #4, while the solid metal hydrides are available within the ball mill #20.

### Waste to Fuel Electrolyzer

This configuration, shown in FIG. 18, supports the high efficiency production of synthetic hydrocarbon fuels and lubricants in addition to Hydrogen from the electrolysis of sea water, brackish water, waste water, natural fresh water, or alkaline water with collection of liquid chlorine in the collector causing a progressive suppression of chlorine production, with the optional heat transfer from the exothermic reaction in the reactor coming from the hydrogenation of carbon rich material like waste or plastic. The end products of the reaction are hydrocarbons with the precise mix depending on the catalyst and the reaction temperature and pressure conditions, and include Synthetic Diesel with the Fischer Tropsch Catalytic process.

The process operates by reacting the waste within the waste reactor (#21) with the high pressure Hydrogen as shown in FIG. 18. A homogenized carbon-rich waste water slurry mix is introduced into the device at the waste input (#22). The flow rate of the input is controlled so that the flow only proceeds when the device can accept more waste. As the input waste water slurry mix flow continues, the waste reactor fills up, and under instructions from sensors and controllers that detect the level within the waste reactor (#21), the input flow stops. The slurry settles within the waste reactor (#21), and then the remaining partially-clean water flows out at electrolysis water exit (#23). This second stage is initiated by sensors and associated control valve on the electrolysis water exit (#23) which opens to allow the flow after a delay. This water flows into the partially-dirty water tank (#24), It is from this tank that the Hydraulic pump (#2) pumps the water into the pressurized electrolytic chamber formed by the flanged pipe (#10) and the matching spherical ends (#9). The water flows from the inlet (#1) and eventually gets electrolyzed within the pressurized electrolytic chamber leading to the presence of high pressure Oxygen in the pipe connected to the Oxygen Outlet (#4), and high pressure Hydrogen in other pipe (#7).

The waste reaction is controlled via the electronically controlled valves: the Hydrogen control valve (#25) and Oxygen control valve (#26). Here, two possibilities arise. Either the process is being cold-started hence the atmosphere within the waste water reactor is oxidizing (approximating the earth atmosphere), or it is reducing (dominated by Hydrogen), which happens once the process is in continuous operation. In case of oxidizing atmosphere, a controlled amount of Hydrogen is introduced into the chamber by momentarily opening the Hydrogen entry (#25). Within the waste reactor close to the bottom, there is a layer of catalyst (e.g.: Silicon Carbide) which causes flameless low temperature Hydrogen Oxygen reactor. The reaction is periodically started and stopped by controlled flow of Hydrogen so that finally the atmosphere within the reactor becomes reducing (introducing more Hydrogen does not raise the temperature, the reactor can sense this state using sensors). Once the reactor is in continuously operating state, it does not have free Oxygen but has free Hydrogen. Then the temperature within the reactor is maintained by controlled opening and dosing of the Oxygen valve (#26). This works because in a Hydrogen atmosphere, Oxygen burns.

The temperature and pressure within the reactor are controlled by the controlled combustion of Hydrogen or Oxygen as described above. This temperature and pressure is chosen based on the waste mix and can span 100-300 C. Under these reducing conditions, the carbon rich waste gets Hydrogenated (eg: Fischer Tropsch process) and forms hydrocarbon fuels and lubricants, as well as other useful chemicals (like Distilled Water, Ammonia, Hydrogen Sulphide, Phosphine, etc.) which are then separated in the distillation column (#27) and are available at various distillation outlets (#28). As the waster within the reactor gets Hydrogenated, it produces heat which is transmitted across the wall of the reactor wall into the partially clean water present within the partially dirty water tank (#24).

The operating pressure within the pressurized electrolytic chamber is up to 1000 bar, as controlled by the pressure relief valves (#13). The operating pressure is kept within 30-1000 bar to create favorable conditions for Hydrogenation reactions. This is done by the periodic introduction of Hydrogen and Oxygen within the reactor from inlets (#26 and #25). As the Hydrogen keeps reacting with the waste, more input is accepted at the input (#22).

A method for producing compressed hydrogen gas, hydrocarbons, and oxygen gas from sea water, waste water, and/or brackish water may comprise: hydraulically pressing a sea water, waste water, and/or brackish water mixture comprising water and waste particles into a pressure sealed electrolytic cell so that the waste particles are collected in a manner so that they are exposed only to hydrogen gas produced at a cathode of the electrolytic cell, wherein the waste particles are introduced into a hydrogen carrying path containing the hydrogen gas produced at the cathode, wherein contact between the hydrogen gas and the waste particles produces hydrocarbons; applying electrical current to break down the water into the hydrogen and oxygen gases resulting in increasing pressure within the sealed electrolytic cell; and releasing the elevated static pressure within the hydrogen and oxygen gases produced by the electrolytic cell using relief valves which harvest the produced hydrogen and oxygen gases in separate containers at a fixed pressure. The hydrogenation reaction with waste is exothermic allowing endothermic electrolysis to take advantage of the heat produced by the hydrogenation of waste plastic for improved electrolytic efficiency.

In this configuration, the additional reaction is the formation of methane and other hydrocarbons as a result of the exothermic hydrogenation of waste and plastics in the reactor stage by reacting the contents with the high pressure Hydrogen being produced at the electrolytic stage. The device allows using the surplus heat from hydrogenation reaction to create additional Hydrogen beyond what would result from the electrical power alone used in the electrolysis. The reaction with waste plastic may be occurring at depth and is exothermic allowing endothermic electrolysis to take advantage of the heat produced by the hydrogenation of waste plastic for improved electrolytic efficiency.

### Solar Thermal Photovoltaic Electrolyzer

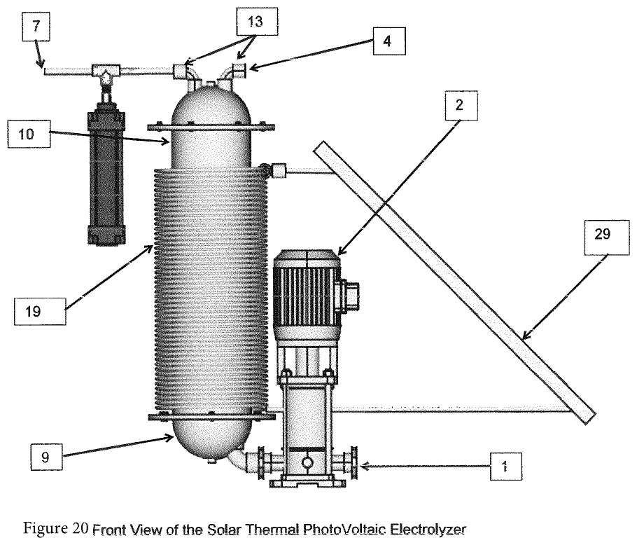

This configuration, as shown in FIG. 20, supports solar photovoltaic power production and Hydrogen production through the electrolysis of sea water, brackish water, waste water, natural fresh water, or alkaline water with collection of liquid chlorine in the collector causing a progressive suppression of chlorine production. This setup produces Hydrogen with compounded efficiency gains because of the optional heat transfer coming from the solar thermal energy (heat absorbed by the panel) collected by one or more photovoltaic cells placed within the solar panel (#29).

The solar heat falling on the solar panel (#29) is carried within the heat exchanger (#19) so that it heats up the electrolytic liquid contained within the pressurized electrolytic chamber formed by the flanged pipe (#10) and the matching spherical ends (#9). The heat transfer decreases the operating temperature of the solar cell, thereby causing production of more photovoltaic power, and hence more Hydrogen than would have happened from the standalone solar photovoltaic cell. However the heat transfer also raises the temperature of the electrolytic liquid, which in turn allows operating the device to produce additional green Hydrogen in the endothermic mode beyond what it would produce from the photovoltaic power alone. These two effects cause compound gains in the overall efficiency of green Hydrogen production using this Solar Thermal Photovoltaic Electrolyzer configuration.

The device may employ magnetic fields, both alternating and static to improve the Hydrogen production rate based on the following physical effects: Alternating magnetic fields have been used to magnetically heat the surface layer of the electrodes which in turn causes abnormal increase in electrolytic rate because of local thermo catalytic effects. Similarly, the Lorentz force may be used to increase the flow rate by having a static vertical magnetic field exist within the electrolytic volume in a direction parallel to the surface of the spiral electrodes. The implied Lorentz force is along the circumference and thus speeds up the electrolytic fluid flow within the electrolytic volume. The existence of this force causes mass flow within the electrolytic fluid thereby increasing efficiency. These static and dynamic magnetic fields are created by passing a direct or alternating electrical current respectively within the helical current path created by the coils of the heat exchanger (#19).

The device may achieve additional mixing and electrolytic efficiency by application of static magnetic field which applies a circumferential Lorentz force on the ions during electrolysis, and a dynamic magnetic field which causes surface catalytic activation on the electrodes leading to improved electrolytic performance.

The optimum performance of the electrolytic reaction is achieved by having the on-board electrical power controller on the device to provide the proper amount of over voltage potential and magnetic fields to drive the electrolytic reactions and the electrolytic fluid flow. These decisions depend on the specific combination of the electrolytic parameters: operating temperature, pressure, composition of the electrolytic fluid/mix, and the electrode materials. The controller may be attached externally as shown in FIG. 9 (#6), or it may be integrated within the body of the high pressure vessel.

The above specific configurations, and the specific dimensions, operating conditions and reactants are exemplary and not limiting. Different combinations can be derived for specific needs based on known physical and chemical properties of elements and compounds. Any useful combination of those is also claimed along with the exemplary configurations described in this application.

During electrolysis the device may achieve optimum performance dynamically by varying the over-voltage potential, and both static and dynamic magnetic fields depending on the operating temperature, pressure, electrolytic fluid composition, and electrode materials (e.g., parameters of the electrolytic cell).

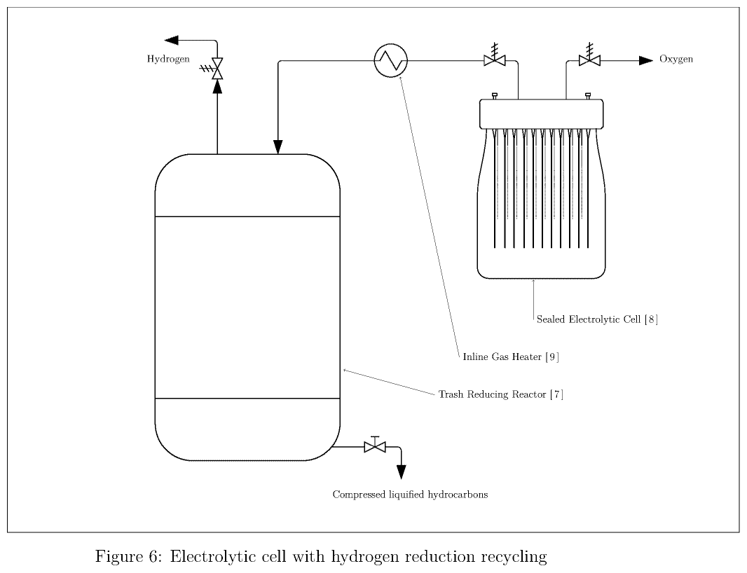

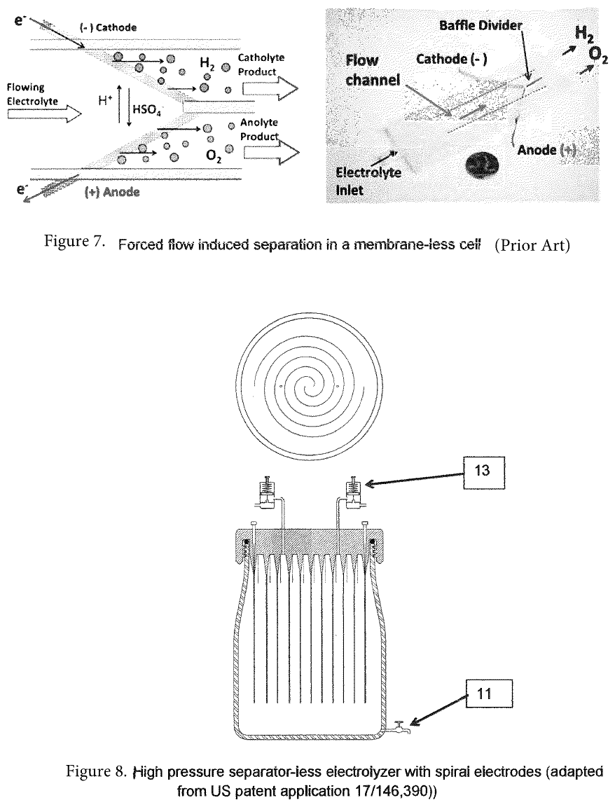

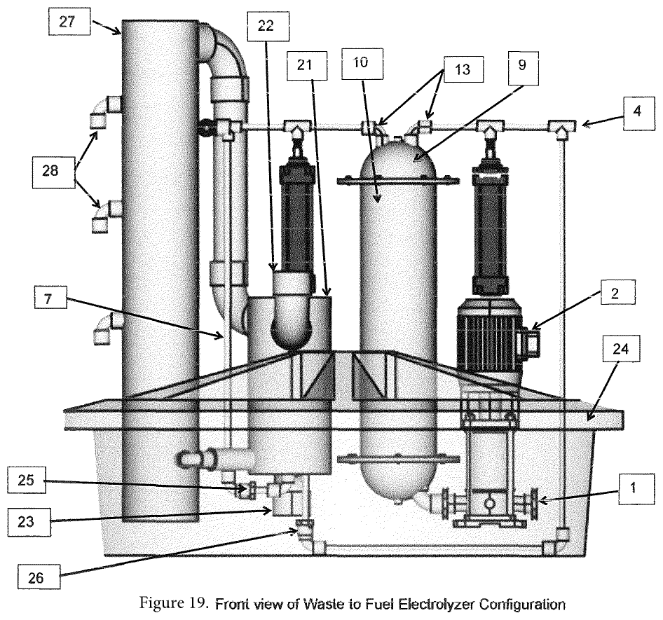

### List of Parts for FIGS. 7-20

1. Electrolytic fluid inlet
2. Pump for pushing the electrolytic fluid within the high pressure electrolyzer
3. Oxygen tank
4. Oxygen output
5. Water gas and liquid overflow
6. Controller
7. Hydrogen output
8. Hydrogen tank
9. Double flanged pipe
10. Hemispherical dead end flange part
11. Collector for liquid waste from high pressure electrolysis
12. Electrolytic liquid input
13. Relief valve
14. Safety valve
15. Electrical input
16. Emergency off
17. Gas exit
18. Gas exit
19. Heat exchanger
20. Ball mill
21. Reactor
22. Dirty water in
23. Partially dirty water for electrolysis
24. Electrolytic liquid tank
25. Hydrogen into reactor
26. Oxygen into reactor
27. Partial distillation column
28. Partial distillation collection points
29. Solar panel with heat transfer to the exchanger

It is also to be understood that the following claims are intended to cover all of the generic and specific features of the invention herein described and all statements of the scope of the invention which, as a matter of language, might be said to fall there between.

What is claimed is:

1. A device for electrolytic decomposition of sea water, waste water, and/or brackish water, the device comprising:
means for maintaining hydrogen and oxygen gases produced during electrolysis of water in an electrolytic cell under pressure using an elevated pressure, relative to atmospheric pressure, and maintaining separation of the hydrogen and oxygen gases produced at two electrodes comprising an anode and a cathode, and extracting the produced hydrogen gas via a hydrogen carrying path at the elevated pressure; and
means for filling up a vessel with sea water, waste water, and/or brackish water in a manner that separates organic wastes in the sea water, waste water, and/or brackish water by flowing the sea water, waste water, and/or brackish water into the hydrogen carrying path to react the organic wastes with the hydrogen gas.

2. The device of claim 1, wherein the vessel is filled with sea water and/or brackish water, the sea water and/or brackish water comprising chlorine, the device comprising:
means for selectively draining out liquid chlorine which liquefies as a result of the elevated pressure of electrolysis resulting in an increasingly alkaline electrolytic mixture, which in turn suppresses the production of chlorine, resulting in an increasing production of the oxygen gas in preference to chlorine at the anode.

3. The device of claim 1, further comprising:
means for electrolytic and/or thermo-catalytic conversion of the sea water, waste water, and/or brackish water into a compressed mixture of hydrocarbons and hydrogen in addition to oxygen, filling up the sea water, waste water, and/or brackish water in a manner that separates the organic wastes into the hydrogen carrying path, and reacting the organic wastes with the hydrogen gas under the influence of photo-catalysis, thermo-catalysis, or physical catalysts and consuming electrical energy to convert the sea water into the compressed mixture under pressure.

4. The device of claim 3, wherein the means for conversion of the sea water, waste water, and/or brackish water into the compressed mixture comprises a reactor filled with the separated organic wastes contacting the hydrogen gas produced by the electrolytic cell and/or a second electrolytic cell in the hydrogen carrying path to generate hydrocarbons.

5. The device of claim 1, wherein the anode and the cathode each form a spiral, wherein the spiral anode is spaced apart from and spirals around the spiral cathode.

6. The device of claim 5, wherein the electrolytic cell comprises the anode and the cathode adjacent to one another, the electrolytic cell further comprising a sloping roof bridging the adjacent anode and cathode and comprising a partial separator, the sloping roof configured to cause gases generated at the anode and the cathode to travel along a spiral path, the partial separator configured to prevent a gas generated at the anode from mixing with a gas generated at the cathode; the electrolytic cell comprising a gas elevator an end of the spiral path, the gas elevator configured to allow the gas generated at the anode to escape to a first outlet of the plurality of outlets and the gas generated at the cathode to escape to a second outlet of the plurality of outlets without mixing thereof.

7. The device of claim 1, wherein the electrolytic cell does not comprise a membrane separator.

8. The device of claim 1, further comprising:
a solar panel; and
a heat exchanger configured to transfer heat energy from the solar panel to reduce a temperature of the solar panel and to transfer heat energy to the water in the electrolytic cell.

9. The device of claim 8, wherein the solar panel produces electrical energy used by the electrolytic cell for the electrolysis.

10. The device of claim 1, further comprising:
a controller configured to adjust an amount of voltage and/or a magnetic field used to drive an electrolytic reaction in the electrolytic cell based on at least one parameter of the electrolytic cell.

11. The device of claim 1, wherein the electrolytic cell autonomously transports the hydrogen and oxygen gases while maintaining separation thereof exclusively by buoyance of the gases and geometry of the electrolytic cell.

12. The device of claim 1, wherein the electrolytic cell comprises a top compartment comprising a first outlet for gas generated at the cathode to escape and a second outlet for gas generated at the anode to escape, wherein a first chamber precedes the first outlet to hold the gas generated at the cathode prior to escape, and a second chamber precedes the second outlet to hold the gas generated at the anode prior to escape, wherein a volume ratio of first chamber to second chamber is within 10% of 2:1.

13. The device of claim 1, wherein waste heat from hydrogenation is used to produce additional hydrogen gas during electrolysis, and the additional hydrogen gas is saved in a form of a solid metal hydride.

14. The device of claim 1, wherein reaction of the organic waste with the hydrogen gas is exothermic, and heat generated from the exothermic reaction is used during the electrolysis.

15. The device of claim 1, wherein the device comprises a controller configured to apply a static magnetic field which applies a circumferential Lorentz force on ions during the electrolysis, and a dynamic magnetic field which causes surface catalytic activation on the anode and the cathode.

16. The device of claim 1, further comprising a controller configured to vary over-voltage potential and both static and dynamic magnetic fields depending on at least one of an operating temperature, pressure, electrolytic fluid composition, and/or electrode materials of the electrolytic cell.

17. A method for producing compressed hydrogen gas and oxygen gas from sea water, waste water, and/or brackish water, the method comprising:
collecting solar energy with solar cells;
conducting electrolysis of sea water, waste water, and/or brackish water in an electrolytic cell in order to produce hydrogen gas and oxygen gas under pressure using the solar energy;
collecting and storing the produced hydrogen gas in a container under pressure; and
separating organic wastes in sea water, waste water, and/or brackish water by reacting organic wastes in the sea water, waste water, and/or brackish water with at least a portion of the hydrogen gas.

18. The method of claim 17, wherein the electrolytic cell comprises an anode and a cathode, wherein the anode and the cathode each form a spiral, wherein the spiral anode is spaced apart from and spirals around the spiral cathode.

19. A method for producing compressed hydrogen gas, hydrocarbons, and oxygen gas from sea water, waste water, and/or brackish water, comprising:
hydraulically pressing a sea water, waste water, and/or brackish water mixture comprising water and waste particles into a pressure sealed electrolytic cell so that the waste particles are collected in a manner so that they are exposed only to hydrogen gas produced at a cathode of the electrolytic cell, wherein the waste particles are introduced into a hydrogen carrying path containing the hydrogen gas produced at the cathode, wherein contact between the hydrogen gas and the waste particles produces hydrocarbons;
applying electrical current to break down the water into the hydrogen and oxygen gases resulting in increasing pressure within the sealed electrolytic cell; and
releasing the elevated static pressure within the hydrogen and oxygen gases produced by the electrolytic cell using relief valves which harvest the produced hydrogen and oxygen gases in separate containers at a fixed pressure.

20. The method of claim 19, comprising sea water and/or brackish water, the method further comprising:
operating at an elevated static pressure, relative to atmospheric pressure, so that chlorine produced at an anode of the electrolytic cell during the electrolysis is in a liquid phase, which in turn being heavier than the water sinks to a bottom of the electrolytic cell and is collected separately; and
continuously removing the chlorine to increase an alkalinity of an electrolytic solution in the electrolytic cell, which suppresses the chlorine production.

21. The method of claim 19, further comprising:
heating the waste particles with the hydrogen gas produced at the cathode to generate the hydrocarbons.

22. The method of claim 19, wherein electrolytic cell comprises an anode and the cathode, wherein the anode and the cathode each form a spiral, wherein the spiral anode is spaced apart from and spirals around the spiral cathode.
